(19) United States
(12) Patent Application Publication
(10) Pub. No.: US 2025/0123889 A1
(43) Pub. Date: Apr. 17, 2025

(54) METHOD AND SYSTEM FOR DYNAMICALLY SCHEDULING EXECUTION OF TASKS

(71) Applicant: HCL Technologies Italy S.p.A., Vimodrone, MI (US)

(72) Inventors: LONGOBARDI GIUSEPPE, Rome (IT); VIOLA STEPHEN ARTHUR, Hillsborough, NC (US)

(21) Appl. No.: 18/379,196

(22) Filed: Oct. 12, 2023

(51) Int. Cl. G06F 9/50

(52) U.S. Cl. CPC G06F 9/5027

(57) ABSTRACT

This disclosure relates to a method and system for dynamically scheduling execution of tasks on an Operating System (OS). The method includes obtaining a plurality of weighted matrices corresponding to a set of tasks to be executed on the OS. The method further includes computing a combined normalized weighted value corresponding to the plurality of weighted matrices. The method further includes determining a deviation of the combined normalized weighted value from a predefined threshold value. The method further includes regulating a throughput rate of execution of the set of tasks based on the deviation.

### TECHNICAL FIELD

This disclosure relates generally to task scheduling systems, and more particularly to a method and a system for dynamically scheduling execution of tasks on an Operating System (OS).

### BACKGROUND

Typically, workload schedulers are used to arrange operations so that they are submitted in batches, in accordance with a pre-defined scheduling plan. The operations to be run are determined by a set of rules. For instance, based on time and a day of a week, an order in which they should be executed properly (in a predecessor/successor dependency chain), their specifics (such as priority, availability of necessary resources, a target machine, etc.), and scheduling system-specific parameters to influence operation starting throughput (for example, number of operations to be started in one minute, or number of operations to be selected for starting in one scheduling submission window). The scheduling plan may be dynamically modified by adding or removing operations along with changing their dependencies along with some of their characteristic. Also, the system where the operations are to be run, may be busy when the operations are selected by a workload scheduler and submitted for actual run by the Operating System (OS). A static definition of the rules influencing the submission throughput might be insufficient and not always effective.

When the system is already very busy and the parameters are configured to allow a high scheduling throughput, this will further exacerbate the situation and lead to significant queueing. For example, in a z/OS® system, a z/OS® scheduler is responsible for submitting Job Control Language (JCL) jobs to Job Entry Sub-system (JES), which is a crucial component of the z/OS® sub-system. The JES handles the job initiation and management processes, ensuring that jobs are executed efficiently and in a right sequence. However, when the JES subsystem becomes overloaded with an excessive number of job requests, and the z/OS® system itself is under a heavy load, this situation can have a detrimental effect. Specifically, it can exacerbate the queuing of jobs and further deteriorate the response times of the OS. On the contrary, in case the parameters are configured to allow a low scheduling throughput when the system is not busy. This can lead to unnecessary delays in job submissions and slow down the execution of the scheduling plan. For example, in the z/OS® system where the JES is lightly loaded and the scheduler is not using it to its full potential, processing may occur at slower pace than what the system is capable of handling.

The present invention is directed to overcome one or more limitations stated above or any other limitations associated with the known arts.

### SUMMARY

In one embodiment, a method for dynamically scheduling the execution of tasks on an Operating System (OS) is disclosed. In one example, the method may include obtaining a plurality of weighted matrices corresponding to a set of tasks to be executed on the OS. The method may further include computing a combined normalized weighted value corresponding to the plurality of weighted matrices. The method may further include determining a deviation of the combined normalized weighted value from a predefined threshold value. It should be noted that the deviation is indicative of processing load of the OS. The method may further include regulating a throughput rate of execution of the set of tasks based on the deviation.

In another embodiment, a system for dynamically scheduling the execution of tasks on an Operating System (OS) is disclosed. In one example, the system may include a processor and a memory communicatively coupled to the processor. The memory may store processor-executable instructions, which, on execution, may cause the processor to obtain a plurality of weighted matrices corresponding to a set of tasks to be executed on the OS. The processor-executable instructions, on execution, may further cause the processor to compute a combined normalized weighted value corresponding to the plurality of weighted matrices. The processor-executable instructions, on execution, may further cause the processor to determine a deviation of the combined normalized weighted value from a predefined threshold value. It should be noted that the deviation is indicative of processing load of the OS. The processor-executable instructions, on execution, may further cause the processor to regulate a throughput rate of execution of the set of tasks based on the deviation.

In yet another embodiment, a non-transitory computer-readable medium storing computer-executable instructions for dynamically scheduling execution of tasks on an Operating System (OS) is disclosed. In one example, the stored instructions, when executed by a processor, may cause the processor to perform operations including obtaining a plurality of weighted matrices corresponding to a set of tasks to be executed on the OS. The operations may further include computing a combined normalized weighted value corresponding to the plurality of weighted matrices. The operations may further include determining a deviation of the combined normalized weighted value from a predefined threshold value. It should be noted that the deviation is indicative of the processing load of the OS. The operations may further include regulating a throughput rate of execution of the set of tasks based on the deviation.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for dynamically scheduling execution of tasks on an Operating System (OS), in accordance with some embodiments of the present disclosure.

FIG. 2 illustrates a functional block diagram of various modules within a memory of a scheduling device configured for dynamically scheduling execution of tasks on an Operating System (OS), in accordance with some embodiments.

FIG. 3 illustrates a flow diagram of an exemplary process for dynamically scheduling execution of tasks on an Operating System (OS), in accordance with some embodiments of the present disclosure.

FIG. 4 illustrates a flow diagram of an exemplary process of regulating a throughput rate of execution based on historical data, in accordance with some embodiments of the present disclosure.

FIG. 5 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

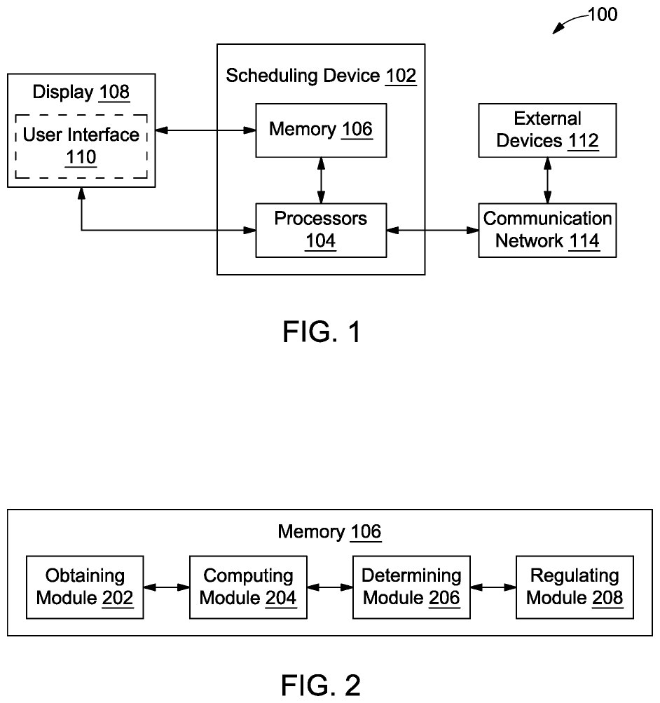

Referring now to FIG. 1, an exemplary system 100 for dynamically scheduling execution of tasks on an Operating System (OS) is illustrated, in accordance with some embodiments of the present disclosure. The system 100 may include a scheduling device 102. Examples of the scheduling device 102 may include, but are not limited to, a server, a desktop, a laptop, a notebook, a netbook, a tablet, a smartphone, a mobile phone, or any other computing device. The scheduling device 102 may dynamically schedule the execution of tasks on the OS. The OS manages computer hardware, software resources, and provides various services for computer programs. The OS serves as an intermediary between a user and computer hardware, allowing users to interact with computers and run applications without needing to understand or manage underlying hardware complexities.

Examples of the OS may include, but are not limited to, Microsoft® Windows®, macOS® (formerly OS X), Linux distributions (such as Ubuntu®, CentOS®, and Fedora®), and mobile operating systems like Android® and iOS®. Further, the tasks may include, but are not limited to, software update tasks, security scans, tasks related to networking, file operations, system processes, running backup tasks, handling user inputs, system maintenance tasks, and the like.

The scheduling device 102 may include one or more processors 104 and a memory 106. The memory 106 may store processor-executable instructions that, when executed by the one or more processors 104, cause the one or more processors 104 to dynamically schedule the execution of tasks on the OS. Various operations may be performed by the one or more processors 104 to schedule the execution of tasks, including obtaining weighted matrices, computing a combined normalized weighted value, determining a deviation of the combined normalized weighted value, and regulating a throughput rate of execution of the set of tasks. The memory 106 may also store various data (for example, the weighted matrices, a set of tasks, the normalized weighted value, the deviation, a response time, a throughput rate, and the like) that may be captured, processed, and/or required by the system 100. The memory 106 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

The system 100 may further include a display 108. The display 108 may further include a User Interface (UI) 110. A user or an administrator may interact with the scheduling device 102 and vice versa via the user interface 110 accessible via the display 108. By way of an example, the display 108 may be used to display results of analysis performed by the scheduling device 102 (such as, for displaying a list of tasks to be executed on an OS, the normalized weighted value, the deviation, the response time, the throughput rate, etc.), to the user. By way of another example, the user interface 110 may be used by the user to provide inputs to the scheduling 102. Thus, for example, in some embodiments, the scheduling device 102 may ingest information provided by the user or the administrator via the user interface 110. Further, for example, in some embodiments, the scheduling device 102 may render results to the user or the administrator via the user interface 110.

The scheduling device 102 may interact with one or more external devices 112 via a communication network 114 for sending and receiving various data. The communication network 114, for example, may be any wired or wireless communication network and the examples may include, but may be not limited to, the Internet, Wireless Local Area Network (WLAN), Wi-Fi, Long Term Evolution (LTE), Worldwide Interoperability for Microwave Access (WiMAX), and General Packet Radio Service (GPRS).

The external devices 112 may include, but may not be limited to, a remote server, a digital device, or another computing system. Examples of the one or more external devices 112 may include but are not limited to, a server, a desktop, a laptop, a notebook, a netbook, a tablet, a smartphone, a mobile phone, or any other computing device. Each of the one or more external devices 112 may have a corresponding OS. For example, the scheduling device 102 may dynamically schedule execution of tasks on an OS of the one or more external devices 112.

Referring now to FIG. 2, a functional block diagram of various modules within the memory 106 of the scheduling device 102 configured for dynamically scheduling execution of tasks on an OS is illustrated, in accordance with some embodiments of the present disclosure. FIG. 2 is explained in conjunction with FIG. 1. The memory 106 may include an obtaining module 202, a computing module 204, a determining module 206, and a regulating module 208.

The obtaining module 202 may be configured for obtaining a plurality of weighted matrices corresponding to a set of tasks to be executed on the OS. It should be noted that each of the plurality of weighted matrices may include one or more matrix elements corresponding to a plurality of predefined parameters associated with the OS executing the set of tasks. The predefined parameters may include, but are not limited to, a response time of task execution, a capacity of Central Processing Unit (CPU), Input-Output (I/O) rates, a disk response time, number of concurrent active tasks/threads, and a network speed. The parameter response time is a measure of how quickly a task is completed by the OS. It indicates efficiency and responsiveness. The parameter-capacity of CPU refers to CPU's processing power or capacity. It may indicate how much computational work the CPU is able to handle at a given time. The parameter I/O rates refer to speed at which data may be read from or written to storage devices like hard drives or Solid State Drives (SSDs). It may be apparent to a person skilled in the art that higher I/O rates lead to faster data access. The disk response time measures time it takes for the storage disk to respond to read or write requests. It may be apparent to a person skilled in the art that the lower disk response times are desirable for faster data access. The obtaining module 202 may be communicatively coupled to the computing module 204.

Once the plurality of weighted matrices is obtained, the computing module 204 may be configured for computing a combined normalized weighted value corresponding to the plurality of weighted matrices. This combined value may represent an aggregated assessment of performance parameters across all the plurality of weighted matrices. The normalized weighted value may be computed through at least one of Principal Component Analysis (PCA), weighted sum technique, weighted vector concatenation, fuzzy logic aggregation, fuzzy logic aggregation, rank aggregation, and machine learning models. The computing module 204 may be communicatively coupled to the determining module 206.

Further, the determining module 206 may be configured for determining a deviation of the combined normalized weighted value from a predefined threshold value. It should be noted that the deviation is indicative of the processing load of the OS. In some embodiments, determining module 206 may include an indicator generator (not shown in FIG. 2) which may be configured for generating at least one indicator of a plurality of indicators based on the deviation. It should be noted that the deviation is at least one of a positive deviation or a negative deviation. The deviation provides information of whether underloading or overloading of the OS. By way of an example, consider that the predefined threshold value is “5” and the combined normalized weighted value computed is “7”. In such a case, the deviation may be “+2” (positive deviation) which means the OS is overloaded by the factor “+2”. In other words, the OS's load is “2” units above the predefined threshold, signifying that the processing load is higher than the OS may ideally handle. By way of another example, consider that the predefined threshold value is “5” and the combined normalized weighted value computed is “1”. In such a case, the deviation may be “−4” (negative deviation) which means the OS is underloaded by the factor “−4”. In other words, the OS's load is “4” units below the predefined threshold, signifying that the processing load is much lower than what the OS may handle.

For example, the plurality of indicators may be different colors for different deviation, or ranges of response time. By way of an example, when there is a positive deviation the indicator generator may generate a red indicator to alert users/administrators/the regulating module 208. Conversely, if there's a negative deviation (indicating underload), indicator generator may generate a green indicator. It should be noted that each of the plurality of indicators is associated with a specific condition or severity level. For example, besides the red and green indicators, there may be yellow indicator for a moderate deviation from the threshold and a purple indicator for severe deviations. In some embodiments, the plurality of indicators may be generated based on range of deviation from the threshold value. For example, for deviation range +1≤D≤+3—an orange indicator, and for deviation D≥+4—a red indicator, may be generated. Other examples of the plurality of indicators may include, but are not limited to, icon or symbol indicators, numeric value indicators, text labels indicators, sound alerts indicators, progress bar indicators, size and shape indicators, and the like. In some embodiments, the determining module 206 may compare the combined normalized weighted value with the predefined threshold value, to determine the deviation. For example, if the combined normalized weighted value is “90” and the threshold value is set at “80”, the determination module based on comparison computes a positive deviation of “10”. After the deviation is determined at least one indicator of the plurality of indicators may be generation and transmitted. The determining module 206 may be operatively coupled to the regulating module 208.

The regulating module 208 may be configured to regulate the throughput rate of execution of the set of tasks based on the deviation. Further, in some embodiments, in real-time, a monitoring system (not shown in FIG. 2) associated with the scheduling device 102 may also monitor characteristics of the OS during the execution of the set of tasks. In other words, the monitoring system continuously tracks and monitors various characteristics of the OS during the execution of a set of tasks in real-time. The characteristics may include CPU usage, memory usage, Input/Output (I/O) operations, network activity, and the like. Further, the monitoring system may store the characteristics of the OS as historical data in an associated database. The historical data provides a record of how the OS has performed under different conditions and workloads over time. Further, for a current cycle of task execution scheduling, the regulating module 208 may check for a similar pattern using the stored historical data. For example, the regulating module 208 checks for patterns or trends in the historical data that may be similar to current conditions and performance of the OS.

By way of an example, the monitoring system may have been collecting data for past six months (historical throughput that may be regulated at that time), and it has been observed that an OS usage tends to spike to 90% during business hours, particularly between 10 AM and 2 PM. Now, during a current cycle, the regulating module 208 is scheduling a new batch of tasks to run on the OS between 10 AM and 2 PM. The regulating module 208 checks the historical data and identifies a similar pattern where usage tends to spike during this time window. Further, when the similar pattern is identified, the regulating module 208 may regulate a current throughput rate of execution of the set of tasks based on a historical throughput rate. The regulating module 208, based on its analysis of the historical data, decides to regulate the current throughput rate of task execution. Referring to the above mentioned example, the regulating module 208 may decide to allocate fewer tasks to the OS during this time window based on the historical throughput rate to prevent the OS from becoming overloaded and maintaining optimal performance.

When task/job submissions need to be performed, a query may be generated to get inputs (i.e., the plurality of weighted matrices) to tune submission throughput. By way of an example, in case of a z/OS® system, a JES subsystem may provide back an indicator based on the threshold. For example, a green indicator, if the JES response time is between 0 and 0.09 seconds, an orange indicator, if the JES response time is between 0.10 and 0.49 seconds, and a red if the JES response time is above 0.50 seconds. Based on the green, orange, red indicators, inputs (it might be a numeric value like 1,2,3 for the 1^{st}, the 2^{nd} and 3^{rd} interval) the scheduling device 102 may regulate the throughput rate. For brevity only 3 indicators are mentioned, however there may be other indicators for different response time. Besides the response time, the capacity of CPU (available and used), other system indicators/resources available/not available (i.e., I/O rates, disk response times, networks speed, and the like) may be considered. The plurality of weighted matrices may be provided directly by a subsystem component, the OS itself, or eventually by a monitoring system (such as Resource Management Facility (RMF) or Omegamon® in system) which monitors both the OS and running-subsystem needed characteristics z/OS®. Also, for example, in the z/OS® system, some System Management Facility (SMF) records, written by system components, might be directly accessed and read to evaluate the need of metrics. In some embodiments, the scheduling device 102 may be directly included in OS running subsystem, making available for use the requested inputs for the scheduling.

It should be noted that all such aforementioned modules 202-208 may be represented as a single module or a combination of different modules. Further, as will be appreciated by those skilled in the art, each of the modules 202-208 may reside, in whole or in parts, on one device or multiple devices in communication with each other. In some embodiments, each of the modules 202-208 may be implemented as dedicated hardware circuit comprising custom application-specific integrated circuit (ASIC) or gate arrays, off-the-shelf semiconductors such as logic chips, transistors, or other discrete components. Each of the modules 202-208 may also be implemented in a programmable hardware device such as a field programmable gate array (FPGA), programmable array logic, programmable logic device, and so forth. Alternatively, each of the modules 202-208 may be implemented in software for execution by various types of processors (e.g., processors 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed dynamically scheduling the execution of tasks on an OS. For example, the exemplary system 100 and the associated scheduling device 102 may dynamically schedule the execution of tasks on the OS by the processes discussed herein. In particular, as will be appreciated by those of ordinary skill in the art, control logic and/or automated routines for performing the techniques and steps described herein may be implemented by the system 100 and the associated scheduling device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors 104 on the system 100.

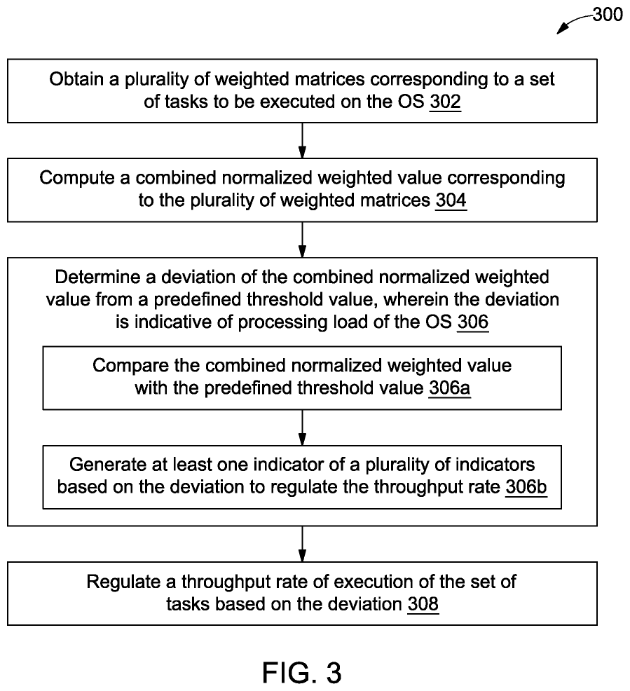

Referring now to FIG. 3, an exemplary process for dynamically scheduling execution of tasks on an Operating System (OS) is depicted via a flowchart 300, in accordance with some embodiments of the present disclosure. Each step of the process may be implemented by the scheduling device 102. FIG. 3 is explained in conjunction with FIGS. 1-2.

At step 302 a plurality of weighted matrices corresponding to a set of tasks to be executed on the OS may be obtained. This step may be performed by the obtaining module 302. It may be noted that each of the plurality of weighted matrices may include one or more matrix elements corresponding to a plurality of predefined parameters associated with the OS executing the set of tasks. The plurality of predefined parameters includes, but are not limited to, a response time, a capacity of a Central Processing Unit (CPU), Input-Output (I/O) rates, a disk response time, and network speed.

At step 304, a combined normalized weighted value corresponding to the plurality of weighted matrices may be computed using the computing module 204. It should be noted that the computation of the combined normalized weighted value may be done using one of a plurality of techniques like Principal Component Analysis (PCA), weighted sum technique, weighted vector concatenation, fuzzy logic aggregation, fuzzy logic aggregation, rank aggregation, and machine learning models.

Thereafter, at step 306, a deviation of the combined normalized weighted value from a predefined threshold value may be determined through the determination module 206. It should be noted that the deviation is indicative of the processing load of the OS. Further, it should be noted that determining the deviation includes sub-steps 306a and 306b. At step 306a, the combined normalized weighted value may be compared with the predefined threshold value. Further, at step 306b, at least one indicator of a plurality of indicators may be generated based on the deviation to regulate a throughput rate. Moreover, the throughput rate refers to how many tasks or processes the OS may successfully execute within a given time frame. In other words, the throughput rate may be OS's ability to efficiently manage and process tasks or processes concurrently. Thus, here, the throughput rate may be in terms of tasks completed per unit of time, such as the tasks per second or tasks per minute.

By way of an example, consider a scenario where the combined normalized weighted value represents a current CPU utilization. If the threshold value is set at 80%, and the determining module 206 calculates a deviation of +10%, it means the CPU load is 10% over the threshold, indicating potential overload.

At step 308, the throughput rate of execution of the set of tasks may be regulated based on the deviation. This step may be performed using the regulating module 308. It should be noted that deviation is at least one of positive deviation or a negative deviation.

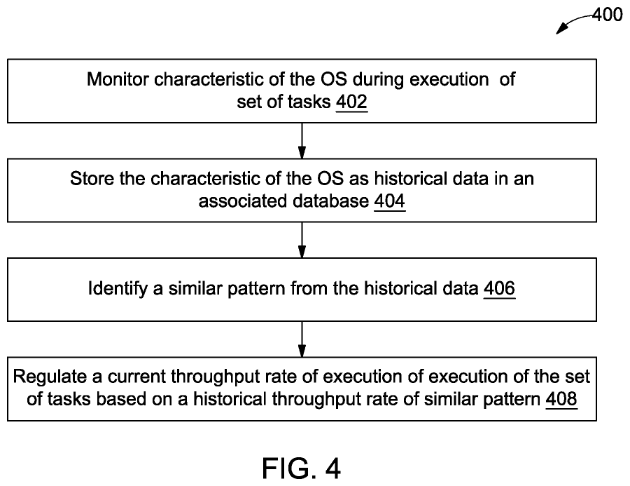

Referring now to FIG. 4, a flow diagram of an exemplary process for regulating a throughput rate of execution is depicted via a flowchart 400, in accordance with some embodiments of the present disclosure. FIG. 4 is explained in conjunction with FIGS. 1-3.

At step 402, characteristics of the OS may be monitored in real-time, during the execution of the set of tasks by a monitoring system associated with the scheduling device 102. Further, at step 404, the characteristic of the OS may be as historical data in an associated database. It should be noted that historical data saved in the database may store all running subsystem characteristics as well. In other words, in some embodiments, various characteristics of the OS may be continuously tracked during the execution of a set of tasks in real-time. The characteristics may include CPU usage, memory usage, Input/Output (I/O) operations, network activity, and the like. By way of an example, the monitoring system may have been collecting data for past six months (historical throughput that may be regulated at that time), and it has been observed that an OS usage tends to spike to 90% during business hours, particularly between 10 AM and 2 PM.

Thereafter, at step 406, for a current cycle of task execution scheduling, a similar pattern may be identified from the historical data using the regulating module 208. Further, at step 408, a current throughput rate of execution of the set of tasks may be regulated based on the historical throughput rate for the similar. With reference to the above example, now, during a current cycle, a new batch of tasks is to be scheduled to run on the OS between 10 AM and 2 PM. Thus, the historical data may be checked, and a similar pattern may be identified where usage tends to spike during this time window. Further, when the similar pattern is identified, a current throughput rate of execution of the set of tasks may be regulated based on the historical throughput rate. The analysis of the historical data may be performed to decide regulation of the current throughput rate of task execution. In such a case, fewer tasks may be allocated to the OS during this time window based on the historical throughput rate to prevent the OS from becoming overloaded and maintaining optimal performance.

As will be also appreciated, the above-described techniques may take the form of computer or controller-implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

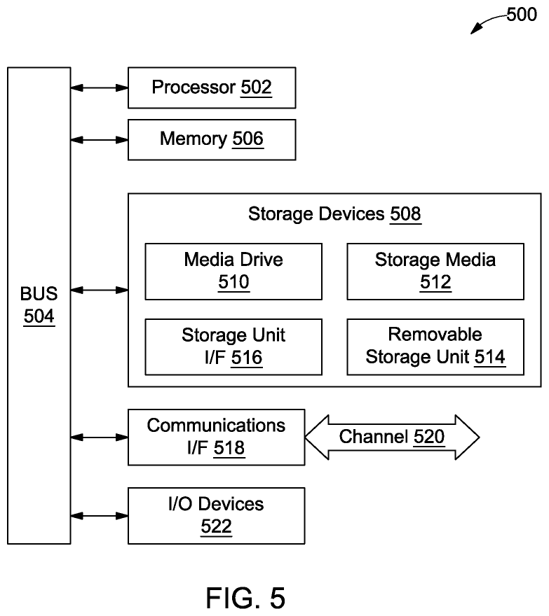

The disclosed methods and systems may be implemented on a conventional or a general-purpose computer system, such as a personal computer (PC) or server computer. Referring now to FIG. 5, an exemplary computing system 500 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 500 may represent, for example, a user device such as a desktop, a laptop, a mobile phone, personal entertainment device, DVR, and so on, or any other type of special or general-purpose scheduling device as may be desirable or appropriate for a given application or environment. The computing system 500 may include one or more processors, such as a processor 502 that may be implemented using a general or special purpose processing engine such as, for example, a microprocessor, microcontroller or other control logic. In this example, the processor 502 is connected to a bus 504 or other communication medium. In some embodiments, the processor 502 may be an Artificial Intelligence (AI) processor, which may be implemented as a Tensor Processing Unit (TPU), or a graphical processor unit, or a custom programmable solution Field-Programmable Gate Array (FPGA).

The computing system 500 may also include a memory 506 (main memory), for example, Random Access Memory (RAM) or other dynamic memory, for storing information and instructions to be executed by the processor 502. The memory 506 also may be used for storing temporary variables or other intermediate information during execution of instructions to be executed by the processor 502. The computing system 500 may likewise include a read only memory (“ROM”) or other static storage device coupled to bus 504 for storing static information and instructions for the processor 502.

The computing system 500 may also include a storage devices 508, which may include, for example, a media drive 510 and a removable storage interface. The media drive 510 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 512 may include, for example, a hard disk, magnetic tape, flash drive, or other fixed or removable medium that is read by and written to by the media drive 510. As these examples illustrate, the storage media 512 may include a computer-readable storage medium having stored therein particular computer software or data.

In alternative embodiments, the storage devices 508 may include other similar instrumentalities for allowing computer programs or other instructions or data to be loaded into the computing system 500. Such instrumentalities may include, for example, a removable storage unit 514 and a storage unit interface 516, such as a program cartridge and cartridge interface, a removable memory (for example, a flash memory or other removable memory module) and memory slot, and other removable storage units and interfaces that allow software and data to be transferred from the removable storage unit 514 to the computing system 500.

The computing system 500 may also include a communications interface 518. The communications interface 518 may be used to allow software and data to be transferred between the computing system 500 and external devices. Examples of the communications interface 518 may include a network interface (such as an Ethernet or other NIC card), a communications port (such as for example, a USB port, a micro USB port), Near field Communication (NFC), etc. Software and data transferred via the communications interface 518 are in the form of signals which may be electronic, electromagnetic, optical, or other signals capable of being received by the communications interface 518. These signals are provided to the communications interface 518 via a channel 520. The channel 520 may carry signals and may be implemented using a wireless medium, wire or cable, fiber optics, or other communications medium. Some examples of the channel 520 may include a phone line, a cellular phone link, an RF link, a Bluetooth link, a network interface, a local or wide area network, and other communications channels.

The computing system 500 may further include Input/Output (I/O) devices 522. Examples may include, but are not limited to a display, keypad, microphone, audio speakers, vibrating motor, LED lights, etc. The I/O devices 522 may receive input from a user and also display an output of the computation performed by the processor 502. In this document, the terms “computer program product” and “computer-readable medium” may be used generally to refer to media such as, for example, the memory 506, the storage devices 508, the removable storage unit 514, or signal(s) on the channel 520. These and other forms of computer-readable media may be involved in providing one or more sequences of one or more instructions to the processor 502 for execution. Such instructions, generally referred to as “computer program code” (which may be grouped in the form of computer programs or other groupings), when executed, enable the computing system 500 to perform features or functions of embodiments of the present invention.

In an embodiment where the elements are implemented using software, the software may be stored in a computer-readable medium and loaded into the computing system 500 using, for example, the removable storage unit 514, the media drive 510 or the communications interface 518. The control logic (in this example, software instructions or computer program code), when executed by the processor 502, causes the processor 502 to perform the functions of the invention as described herein.

Various embodiments provide method and system for dynamically scheduling the execution of tasks on an Operating System (OS). The disclosed method and system may obtain a plurality of weighted matrices corresponding to a set of tasks to be executed on the OS. Each of the plurality of weighted matrices includes one or more matrix elements corresponding to a plurality of predefined parameters associated with the OS executing the set of tasks. Further, the disclosed method and system compute a combined normalized weighted value corresponding to the plurality of weighted matrices. Moreover, the disclosed method and system may determine a deviation of the combined normalized weighted value from a predefined threshold value. The deviation is indicative of the processing load of the OS. Thereafter, the disclosed method and system may regulate a throughput rate of execution of the set of tasks based on the deviation.

Thus, the disclosure tries to overcome the technical problem of scheduling the execution of tasks on an Operating System (OS). The disclosure provides optimized submission rate based on real condition of the OS and further, assists to keep a constant submission flow rate. By dynamically adjusting the submission rate based on real-time OS conditions, the disclosure minimizes the risk of flooding the OS and associated system with too many tasks during busy periods or submitting too few tasks during idle times. This ensures efficient resource utilization. The disclosure optimizes allocation of resources by aligning the submission rate with the actual processing capacity of the OS. This prevents overloading and underutilization, leading to better overall resource efficiency. The disclosure provides smoother task execution and more predictable response times, improving the user experience. Moreover, the disclosure provides users and applications benefits from the OS that can consistently handle their requests without excessive delays or downtime. This leads to higher user satisfaction and productivity.

Further, the disclosure may also provide an indication of the risk to overcome possibility of overloading and underloading in certain intervals. The disclosure enables an effective automatic self-adaptive setting of the parameters to cause operation submission rate on the real OS conditions and an automatic adaptation submission rate in scheduling device 102, based on the detected capacity of the OS. The disclosure leverages historical data to make informed decisions about how to adjust the task execution rate in real-time. This proactive approach helps prevent performance issues and ensures that the OS operates efficiently under varying workloads. By considering the historical data, the disclosure helps in proactively assessing the risk of overloading the OS's capacity during specific intervals. This allows for better planning and resource allocation, reducing the likelihood of performance bottlenecks.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for dynamically scheduling execution of tasks on an OS. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of dynamically scheduling execution of tasks on an Operating System (OS), the method comprising:
obtaining, by a scheduling device, a plurality of weighted matrices corresponding to a set of tasks to be executed on the OS;
computing, by the scheduling device, a combined normalized weighted value corresponding to the plurality of weighted matrices;
determining, by the scheduling device, a deviation of the combined normalized weighted value from a predefined threshold value, wherein the deviation is indicative of processing load of the OS; and
regulating, by the scheduling device, a throughput rate of execution of the set of tasks based on the deviation.

2. The method of claim 1, wherein each of the plurality of weighted matrices comprises one or more matrix elements corresponding to a plurality of predefined parameters associated with the OS executing the set of tasks.

3. The method of claim 2, wherein the plurality predefined parameters comprises a response time, a capacity of Central Processing Unit (CPU), Input-Output (I/O) rates, a disk response time, and a network speed.

4. The method of claim 1, wherein determining the deviation comprises comparing the combined normalized weighted value with the predefined threshold value.

5. The method of claim 1, comprising generating at least one indicator of a plurality of indicators based on the deviation to regulate the throughput rate.

6. The method of claim 1, wherein the deviation is at least one of a positive deviation or a negative deviation.

7. The method of claim 1, further comprising:
monitoring, in real-time, characteristics of the OS during execution of the set of tasks; and
storing the characteristics of the OS as historical data in an associated database.

8. The method of claim 7, further comprising:
for a current cycle of task execution scheduling,
identifying a similar pattern from the historical data; and
regulating a current throughput rate of execution of the set of tasks based on a historical throughput rate for the similar pattern.

9. A system for dynamically scheduling execution of tasks on an Operating System (OS), the system comprising:
a processor; and
a memory communicatively coupled to the processor, wherein the memory stores processor-executable instructions, which when executed by the processor, cause the processor to:
obtain a plurality of weighted matrices corresponding to a set of tasks to be executed on the OS;
compute a combined normalized weighted value corresponding to the plurality of weighted matrices;
determine a deviation of the combined normalized weighted value from a predefined threshold value, wherein the deviation is indicative of the processing load of the OS; and
regulate a throughput rate of execution of the set of tasks based on the deviation.

10. The system of claim 9, wherein each of the plurality of weighted matrices comprises one or more matrix elements corresponding to a plurality of predefined parameters associated with the OS executing the set of tasks.

11. The system of claim 10, wherein the plurality predefined parameters comprises a response time, a capacity of Central Processing Unit (CPU), Input-Output (I/O) rates, a disk response time, and a network speed.

12. The system of claim 9, wherein the processor-executable instructions, on execution, further cause the processor to determine the deviation by comparing the combined normalized weighted value with the predefined threshold value.

13. The system of claim 9, wherein the processor-executable instructions, on execution, further cause the processor to generate at least one indicator of a plurality of indicators based on the deviation to regulate the throughput rate.

14. The system of claim 9, wherein the deviation is at least one of a positive deviation or a negative deviation.

15. The system of claim 9, wherein the processor-executable instructions, on execution, further cause the processor to:
monitor characteristics of the OS during execution of the set of tasks; and
store the characteristics of the OS as historical data in an associated database.

16. The system of claim 15, wherein the processor-executable instructions, on execution, further cause the processor to:
for a current cycle of task execution scheduling further,
identify a similar pattern from the historical data; and
regulate a current throughput rate of execution of the set of tasks based on a historical throughput rate for the similar pattern.

17. A non-transitory computer-readable medium storing computer-executable instructions for dynamically scheduling execution of tasks on an Operating System (OS), the computer-executable instructions configured for:
obtaining a plurality of weighted matrices corresponding to a set of tasks to be executed on the OS;
computing a combined normalized weighted value corresponding to the plurality of weighted matrices;
determining a deviation of the combined normalized weighted value from a predefined threshold value, wherein the deviation is indicative of processing load of the OS; and
regulating a throughput rate of execution of the set of tasks based on the deviation.

18. The non-transitory computer-readable medium of claim 17, wherein each of the plurality of weighted matrices comprises one or more matrix elements corresponding to a plurality of predefined parameters associated with the OS executing the set of tasks, and wherein the plurality predefined parameters comprises a response time, a capacity of Central Processing Unit (CPU), Input-Output (I/O) rates, a disk response time, and a network speed.

19. The non-transitory computer-readable medium of claim 17, wherein the computer-executable instructions further configured for:
monitoring characteristics of the OS during execution of the set of tasks; and
storing the characteristics of the OS as historical data in an associated database.

20. The non-transitory computer-readable medium of claim 19, wherein the computer-executable instructions further configured for:
for a current cycle of task execution scheduling further,
identifying a similar pattern from the historical data; and
regulating a current throughput rate of execution of the set of tasks based on a historical throughput rate for the similar pattern.
